(19) United States
(12) Patent Application Publication
(10) Pub. No.: US 2006/0254381 A1
(43) Pub. Date: Nov. 16, 2006

(54) Cable guide for bicycle

(76) Inventor: Jason L. Chamberlain, Morgan Hill, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/125,905

(22) Filed: May 10, 2005

(51) Int. Cl. F16C 1/10

(52) U.S. Cl. 74/502.4

(57) ABSTRACT

A cable guide configured to be connectable to a bicycle and, preferably, permit movement of a bicycle control cable relative to the cable guide. The guide includes a body having a first end portion, a second end portion, and an intermediate portion between the first and second end portions. The body has an internal passage that is sized to accommodate a bicycle control cable and permit the control cable to slide within the internal passage along a longitudinal axis of the guide. A cross-sectional area of the internal passage is enlarged at at least one of the first and second end portions relative to the intermediate portion. In one arrangement, the cable guide is constructed of multiple pieces to permit assembly over an installed control cable.

### BACKGROUND OF THE INVENTION

1. Field of the Invention

The present invention relates to bicycles and, more specifically, to a cable guide for a bicycle.

2. Description of the Related Art

Bicycles often use control cables to interconnect a rider control mechanism with a system component of the bicycle. The rider control mechanism may be a manual lever or a shifter mechanism mounted on a handlebar of the bicycle, among other possible controls. The system component may be a front or a rear wheel brake, transmission component, or a suspension lock-out device, among other possibilities. The control cable often is either a mechanical assembly (e.g., a combination of inner wire and outer housing) or a hydraulic line. The control cable extends from the rider control mechanism, typically mounted on the handlebar, to the system component, which may be located on the bicycle at a significant distance from the handlebar. Accordingly, it is often desirable to secure the control cable to a portion of the bicycle at one or more locations between the rider control mechanism and the system component to keep the control cable from interfering with the rider, movable components of the bicycle or other objects.

Many prior art arrangements for securing the control cable to the bicycle operate as clamps to tightly secure the cable to the bicycle at a location. With such a device, the cable is constrained from moving relative to the clamp or the bicycle. While such an arrangement may be permissible in applications where little or no movement of the control cable is expected to occur, it is less desirable in applications where portions of the bicycle may move. For example, an application for a suspension bicycle where the front or rear wheels are mounted on suspension assemblies that permit movement of the wheels relative to the main frame of the bicycle. When the cable is clamped at one or more locations to a full suspension bicycle, it is often necessary to provide significant excess cable, or cable slack, in order to accommodate changes in the effective length of the cable due to the suspension movement of the front or rear wheels. Such an arrangement is undesirable because the excess cable slack may interfere with the rider, moving parts of the bicycle, or other objects, such as a rock or tree branch, for example. Furthermore, the excess cable results in an undesirable appearance of the bicycle.

### SUMMARY OF THE INVENTION

Preferred embodiments of the present cable guide are configured to secure the control cable near a desired location on the bicycle and, preferably, permit the cable to slide relative to the cable guide. With such an arrangement, it is not necessary to provide a large amount of excess cable in order to accommodate suspension movement of the front or rear wheels. Furthermore, preferred embodiments are configured to facilitate the sliding of the cable relative to the cable guide, even when the cable enters or exits the guide at an angle. The preferred embodiments are also simple and convenient to install and are compatible with a common cable mounting boss structure.

A preferred embodiment is a cable guide configured to be connectable to a bicycle and including a body having a first end portion, a second end portion, and an intermediate portion between the first and second end portions. The body has an inner surface which forms an internal passage defining a longitudinal axis. The internal passage is sized to receive a bicycle control cable and permit the control cable to slide within the internal passage along the longitudinal axis. A cross-sectional area of the internal passage is larger at at least one of the first and second end portions than at the intermediate portion.

Another preferred embodiment is a cable guide configured to guide a bicycle control cable and being mountable onto a bicycle. The cable guide includes a first half having a first mating surface, and a second half having a second mating surface. The first half and the second half are configured to be connectable, such that the first mating surface faces the second mating surface, and the first and second halves together form a cable guide passage. The cable guide passage defines a longitudinal axis along which the bicycle control cable passes through the cable guide passage. The guide passage is enlarged at at least one end relative to an intermediate portion of the guide passage.

Another preferred embodiment is an assembly including a first cable guide portion having a first mating surface and a second cable guide portion having a second mating surface. The first cable guide portion and the second cable guide portion are configured to be connectable to form a cable guide such that the first mating surface faces the second mating surface and together form a cable guide passage defining a longitudinal axis along which a bicycle control cable may pass through the cable guide passage. The cable guide has a first end portion, a second end portion and an intermediate portion between the first and second end portions. The guide passage defines an outwardly curving surface at at least one of the first end portion and the second end portion.

### BRIEF DESCRIPTION OF THE DRAWINGS

These and other features, aspects, and advantages of the present invention are described below with reference to drawings of a preferred embodiment, which is intended to illustrate, but not to limit, the present invention. The drawings contain four figures.

FIG. 1 is a perspective view of one half of a preferred embodiment of a cable guide.

FIG. 2 is an end view of two halves of the cable guide connected together to form a cable passage. FIG. 2 also illustrates a control cable passing through the cable guide passage.

FIG. 3 is a partial view of a bicycle frame including a cable mounting boss.

FIG. 4 illustrates the cable guide of FIGS. 1 and 2 secured to the cable mounting boss of FIG. 3.

### DETAILED DESCRIPTION OF THE PREFERRED EMBODIMENT

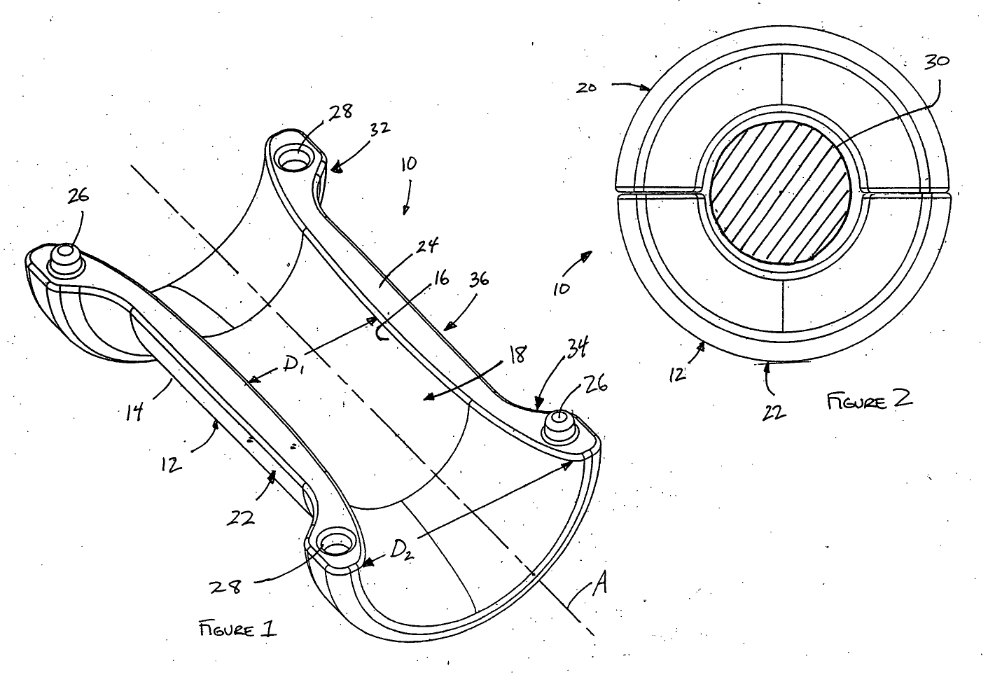

FIGS. 1 and 2 illustrate a preferred embodiment of a cable guide 10. The cable guide 10 includes one or more pieces that define a body 12. Preferably, the body 12 is generally tubular in shape and defines an outward facing surface, or outer surface 14 and an inward facing surface, or inner surface 16. The inward facing surface 16 defines a cable guide passage 18 of the cable guide 10, which is sized and shape to accommodate a bicycle cable. Desirably, the passage 18 is configured to permit the cable to move relative to the guide 10.

In the illustrated arrangement, the cable guide body 12 is constructed of two halves 20 and 22. Each half 20, 22 defines a mating surface 24. The mating surfaces 24 of each half 20, 22 face one another when the halves 20, 22 are assembled together, as illustrated in FIG. 2. Preferably, the mating surfaces 24 contact one another when the halves 20, 22 are assembled.

Preferably, when the halves 20, 22 are assembled, the mating surfaces 24 define a plane that passes through a longitudinal axis A of the passage 18. In the illustrated arrangement, the mating surfaces 24 of the halves 20, 22 thus bisect the cable clamp body 12 and, as a result, the halves 20, 22 are mirror images of one another. However, in alternative arrangements, the cable guide 10 may be comprised of more than one component that are not mirror images of one another or do not bisect the cable guide 10. Accordingly, as used herein, the term “half” or “halves” is not limited to a member that defines an equal portion of the body 12 along with another member, but only that the two members cooperate to form all or part of the body 12. Such a multiple piece construction permits the guide 10 to be assembled over a cable that has been previously installed on a bicycle, without requiring disassembly of the cable. In other arrangements, however, the cable guide 10 may include a body 12 that constructed from more than two pieces or, alternatively, that is constructed as a single piece and is configured to be slid over the end of a control cable.

With reference to FIG. 1, preferably each half 20, 22 of the cable guide 10 include one or more projections 26 and one or more cavities 28. The projections of one half 20, 22 cooperate with the cavities 28 of the other half 20, 22 to position the halves 20, 22 relative to one another. The projections 26 and cavities 28 preferably also inhibit longitudinal movement of the halves 20, 22 relative to one another. If desired, the projections 26 and cavities 28 may be configured as a snap fit arrangement to provide a resistive force to separation of the halves 20, 22 once assembled.

In the illustrated arrangement, the projections 26 and cavities 28 are located on the mating surface 24 and, preferably, are positioned near the ends of the halves 20, 22. Desirably, one each of a projection 26 and cavity 28 are provided on each end of the half 22. Preferably, the projections 26 and cavities 28 are located on an opposite side of the longitudinal axis A from the projection 26 and cavity 28 of the other end. Accordingly, although the halves 20, 22, with the exception of the projections 26 and cavities 28, appear as mirror images of one another, in reality each half 20, 22 preferably is identical to the other so that only one mold is necessary to fabricate each half 20, 22 of the cable guide 10.

As described above, preferably the cable guide 10 is configured to permit a cable 30 to slide within the guide passage 18. Furthermore, in preferred arrangements, the cable 30 is permitted to move relative to the guide 10 even when the cable 30 enters or exits the guide passage 18 at an angle from the longitudinal axis A. To facilitate the sliding movement of the cable 30, preferably the passage 18 is enlarged at at least one of a first end portion 32 and a second end portion 34 of the cable guide body 12 relative to an intermediate portion 36 body 12.

In the illustrated arrangement, the guide passage 18 is circular in cross-sectional shape and defines a diameter D₁. Preferably, the inward facing surface 16 moves away from the longitudinal axis A when moving outwardly from the intermediate portion 36 along the longitudinal axis A toward at least one of the end portions 32 or 34. That is, desirably, a cross-sectional dimension of the inward facing surface 16 enlarges at one or both end portions 32, 34 relative to its dimension within the intermediate portion 36. Preferably, the guide passage 18 is enlarged at each end portion 32, 34 to define an outlet diameter D₂. However, in an alternative arrangement, only one or the other of the end portions 32, 34 may be enlarged. The enlarged end portions 32, 34 facilitate sliding of the cable 30 relative to the guide 10 when the cable 30 enters or exits the guide 10 at an angle relative to the longitudinal axis A.

In the illustrated arrangement, the inward facing surface 16 is curved along the entire length of the passage 18. However, preferably, the inward facing surface 16 moves away from the longitudinal axis A at a greater rate within the end portions 32, 34 than within the intermediate portion 36. That is, preferably, the inward facing surface 16 in the intermediate portion is less curved than the inward facing surface 16 of the end portions 32, 34.

Desirably, a length of the passage 18 is approximately 2.5 times a dimension of the diameter D₁. In addition, preferably, the diameter D₂ is approximately 66 percent greater than the diameter D₁. Such an arrangement advantageously maintains the cable 30 close to a desired location on the associated bicycle while allowing entry and exit of the cable 30 into and out of the guide 10, even when the cable 30 is oriented at an angle relative to the longitudinal axis A. Furthermore, desirably, the transition between the inward facing surface at the intermediate portion 36 and the inward facing surface 16 at the end portions 32, 34 is relatively smooth. That is, preferably, there is not a drastic transition between the intermediate portion 36 and the end portions 32, 34 that may apply a significant resistive force to movement of the cable 30. However, in other arrangements, the intermediate section may be of a uniform cross-section along its length and the end portions 32, 34 extend at an angle from the intermediate portion 36. Preferably, even in such an arrangement, the transition between the intermediate portion 36 and end portions 32, 34 would be chamfered or otherwise smoothed.

In the illustrated arrangement, the outward facing surface 14 is generally cylindrical within the intermediate portion 36 of the guide 10. Desirably, the outward facing surface 14 extends outwardly at the end portions 32, 34. With such an arrangement, the outward facing surface 14 of the intermediate portion 36 is configured to be clamped by a fastening member, such as a cable tie 52 (FIG. 4), which will inhibit longitudinal movement of the cable guide 10 by interference between the fastening member 52 and the enlarged outward facing surface 14 at the end portions 32 and 34.

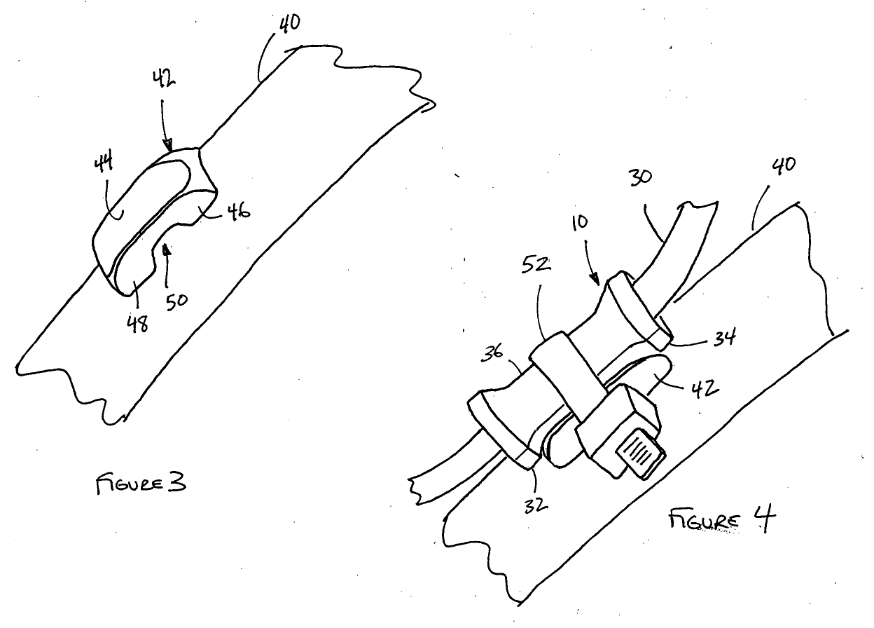

FIG. 3 illustrates a structural component of a bicycle and, more precisely, a bicycle frame tube 40. The tube 40 may be any portion of a bicycle, such as a main frame tube or a wheel support tube, for example. The tube 40 includes a cable mounting boss 42 of a generally standard construction. The mounting boss 42 may be secured to the frame tube 40 by a suitable method, such as brazing or welding, for example. An outward facing surface of the boss 42 is concave and defines a channel 44, which is generally semi-cylindrical in shape.

The boss 42 is secured to the frame tube 40 at spaced portions 46, 48. The boss 42 includes a recess between the portions 46 and 48 to define a passage 50 when the boss 42 is secured to the frame tube 40. The passage 50 extends substantially perpendicular to the longitudinal axis of the channel 44. Typically, the channel 44 is configured to receive a control cable 30 (FIG. 2). In a prior art arrangement, a securing member, such as a cable tie, is passed through the passage 50 and around both the boss 42 and cable 30 to secure the cable 30 to the boss 42. However, as noted above, when the cable tie is cinched tightly around the cable 30, the cable 30 will be unable to move relative to the boss 42, or will be unlikely to move in response to forces typically applied to the cable during use of the associated bicycle, such as a result of suspension movement of the front or rear wheels of the bicycle. Accordingly, an often significant amount of excess cable slack will need to be provided to accommodate movement of suspension portions of the bicycle.

FIG. 4 illustrates the cable guide 10 of FIGS. 1 and 2 secured to the mounting boss 42 by an attachment member, such as a cable tie 52; Thus, although the cable guide 10 preferably is fixed relative to the boss 42, the cable 30 may move relative to the cable guide 10, as described above, and also relative to the frame tube 40.

Desirably, the outside length and shape of the cable guide 10 is configured to compliment the shape of the mounting boss 42. Desirably, the intermediate portion 36 rests within the channel 44, and the end portions 32, 34 contact end surfaces of the mounting boss 42 to inhibit relative movement of the cable guide 10 along the longitudinal axis of the mounting boss 42. Such a construction reduces the force on the cable tie 52 in a direction along the longitudinal axis of the mounting boss 42. Although such a mounting boss 42 is commonly provided on bicycles, the cable guide 10 may be secured to a component of a bicycle by other suitable means, such as the use of cable ties 52 or other attachment brackets.

Although this invention has been disclosed in the context of a certain preferred embodiment and example, it will be understood by those skilled in the art that the present invention extends beyond the specifically disclosed embodiment to other alternative embodiments and/or uses of the invention and obvious modifications and equivalents thereof. In particular, while the present bicycle cable guide has been described in the context of a particularly preferred embodiment, the skilled artisan will appreciate, in view of the present disclosure, that certain advantages, features, and aspects of the cable guide may be realized in a variety of other applications, many of which have been noted above. Additionally, it is contemplated that various aspects and features of the invention described can be practiced separately, combined together, or substituted for one another, and that a variety of combination and subcombinations of the features and aspects can be made and still fall within the scope of the invention. Thus, it is intended that the scope of the present invention herein disclosed should not be limited by the particular disclosed embodiment described above, but should be determined only by a fair reading of the claims.

What is claimed is:

1. A cable guide configured to be connectable to a bicycle and comprising a body having a first end portion, a second end portion and an intermediate portion between said first and second end portions, said body having an inner surface which forms an internal passage defining a longitudinal axis, said internal passage sized to receive a bicycle control cable and permit said control cable to slide within said internal passage along said longitudinal axis, wherein a cross-sectional area of said internal passage is larger at at least one of said first and second end portions than at said intermediate portion.

2. The cable guide of claim 1, wherein a cross-sectional area of said internal passage is larger at both said first and second end portions than at said intermediate portion.

3. The cable guide of claim 1, wherein said internal passage is circular in cross-sectional shape.

4. The cable guide of claim 1, wherein at least one of said first and second end portions of said internal passage defines an outwardly curving surface.

5. The cable guide of claim 1, wherein said inner surface is continuously curved between said first end portion and said second end portion.

6. The cable guide of claim 1, wherein a length of said cable guide body is approximately 2.5 times greater than a minimum cross-sectional dimension of said internal passage.

7. The cable guide of claim 6, wherein a maximum cross-sectional dimension of said internal passage is approximately 66% greater than a minimum cross-sectional dimension of said internal passage.

8. The cable guide of claim 1, wherein said body defines an outer surface defining a first cross-sectional dimension at an intermediate portion and having enlarged end portions defining a second cross-sectional dimension that is greater than said first cross-sectional dimension.

9. The cable guide of claim 8, wherein an outer surface of said body is sized and shaped to be received by a cable mounting boss defining concave mounting cable mounting surface.

10. The cable guide of claim 9, wherein said enlarged end portions are configured to contact end surfaces of said cable mounting boss to inhibit movement of said cable guide in a direction along said longitudinal axis.

11. The cable guide of claim 10, wherein said outer surface is circular in cross-sectional shape.

12. A cable guide configured to guide a bicycle control cable and mountable onto a bicycle, comprising:
a first half having a first mating surface; and
a second half having a second mating surface, said first half and said second half configured to be connectable such that said first mating surface faces said second mating surface and together form a cable guide passage defining a longitudinal axis along which the bicycle control cable passes through said cable guide passage, said cable guide having a first end portion, a second end portion and an intermediate portion between said first and second end portions;
wherein said guide passage is enlarged at at least one of said first end portion and said second end portion relative to said guide passage at an intermediate portion of said cable guide.

13. The cable guide of claim 12, wherein said guide passage is enlarged at each of said first end portion and said second end portion relative to said intermediate portion.

14. The cable guide of claim 12, wherein a surface of said guide passage is continuously curved between said first end portion and said second end portion.

15. The cable guide of claim 12, wherein said first half comprises at least one projection and at least one cavity and said second half comprises at least one projection and at least one cavity, said cavities configured to receive said projections to inhibit relative movement of said first half and said second half along said longitudinal axis.

16. The cable guide of claim 12, wherein said first half and said second half of said cable guide cooperate to form an outer surface of said cable guide, said outer surface defining a first cross-sectional dimension at an intermediate portion and having enlarged end portions defining a second cross-sectional dimension that is greater than said first cross-sectional dimension.

17. The cable guide of claim 16, wherein said outer surface of said cable guide is sized and shaped to be received by a cable mounting boss defining concave mounting cable mounting surface and wherein said enlarged end portions are configured to contact end surfaces of said cable mounting boss to inhibit movement of said cable guide in a direction along said longitudinal axis.

18. An assembly, comprising:
a first cable guide portion having a first mating surface; and
a second cable guide portion having a second mating surface, said first cable guide portion and said second cable guide portion configured to be connectable to form a cable guide such that said first mating surface faces said second mating surface and together form a cable guide passage defining a longitudinal axis along which a bicycle control cable may pass through said cable guide passage, said cable guide having a first end portion, a second end portion and an intermediate portion between said first and second end portions, wherein said guide passage defines an outwardly curving surface at at least one of said first end portion and said second end portion.

19. The assembly of claim 18, additionally comprising a control cable passing through said cable guide passage.

20. The assembly of claim 19, wherein said cable guide is secured to a bicycle.
